(19) United States
(12) Patent Application Publication
(10) Pub. No.: US 2026/0205794 A1
(43) Pub. Date: Jul. 16, 2026

(54) HYBRID MULTI-LINK DEVICE WIRELESS NETWORKING FOR AUTOMOTIVE

(71) Applicant: Cisco Technology, Inc., San Jose, CA (US)

(72) Inventors: Domenico Ficara, Essertines-Sur-Yverdon (CH); Ugo Mario Campiglio, Morges (CH); Federico Lovison, Fontanelle (IT); Javier Contreras, Barcelona (ES); Juan Carlos Zuniga, Montreal (CA); Suresh Krishnan, Suwanee, GA (US)

(21) Appl. No.: 19/445,058

(22) Filed: Jan. 9, 2026

Related U.S. Application Data
(60) Provisional application No. 63/744,005, filed on Jan. 10, 2025.

(51) Int. Cl. H04W 8/00; H04W 12/06; H04W 60/04; H04W 64/00; H04W 84/12

(52) U.S. Cl. CPC H04W 8/005; H04W 12/06; H04W 60/04; H04W 64/00; H04W 84/12

(57) ABSTRACT

Hybrid Multi-Link Device (MLD) wireless networking for automotive may be provided. A mobile device can, using an out-of-band (OOB) connection, discover a virtual access point (AP) that provides wireless local area network (WLAN) services. Information identifying a service area and APs within the service area is received from the virtual AP via the OOB connection. A virtual wireless network session is established with the virtual AP over the OOB connection in response to determining the mobile device is entering the service area, including performing an association procedure and an authentication procedure between the mobile device and the virtual AP. In response to determining that the mobile device is entering a WLAN coverage area associated with an AP of the APs, a link is established between the mobile device and the AP. Data is then exchanged between the mobile device and an application via the link through the AP.

### RELATED APPLICATION

Under provisions of 35 U.S.C. § 119(e), Applicant claims the benefit of and priority to U.S. Provisional Application No. 63/744,005, filed January 10, 2025, the disclosure of which is incorporated herein by reference in its entirety.

### TECHNICAL FIELD

The present disclosure relates generally to providing hybrid Multi-Link Device (MLD) wireless networking for automotive.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for hybrid Multi-Link Device (MLD) wireless networking in accordance with aspects of the present disclosure.

FIG. 2 is a block diagram of an example mobile device in accordance with aspects of the present disclosure.

FIG. 3 is a diagram of a service availability determination process in accordance with aspects of the present disclosure.

FIG. 4 is a diagram of a session establishment process when entering a service area in accordance with aspects of the present disclosure.

FIG. 5 is a diagram of an access point (AP) link establishment process when entering a wireless local area network (WLAN) coverage area in accordance with aspects of the present disclosure.

FIG. 6 is a flow chart of a method for hybrid MLD wireless networking in accordance with aspects of the present disclosure.

FIG. 7 is a block diagram of a computing device in accordance with aspects of the present disclosure.

FIG. 8 is a block diagram of a communications device in accordance with aspects of the present disclosure.

### DETAILED DESCRIPTION

### OVERVIEW

Hybrid Multi-Link Device (MLD) wireless networking for automotive may be provided. A mobile device can, using an out-of-band (OOB) connection, discover a virtual access point (AP) that provides wireless local area network (WLAN) services. Information identifying a service area and APs within the service area is received from the virtual AP via the OOB connection. A virtual wireless network session is established with the virtual AP over the OOB connection in response to determining the mobile device is entering the service area, including performing an association procedure and an authentication procedure between the mobile device and the virtual AP. In response to determining that the mobile device is entering a WLAN coverage area associated with an AP of the APs, a link is established between the mobile device and the AP. Data is then exchanged between the mobile device and an application via the link through the AP.

Both the foregoing overview and the following example embodiments are examples and explanatory only and should not be considered to restrict the disclosure’s scope, as described, and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The Institute of Electrical and Electronics Engineers (IEEE) 802.11 Automotive Task Interest Group has initiated efforts to enable vehicle connectivity through 802.11 wireless networks (e.g., Wi-Fi) with aid from other technologies. This connectivity can be enabled for mobile devices such as vehicles traveling below a threshold speed, such as in scenarios where mobile devices are moving at speeds under forty kilometers per hour. This approach envisions mobile devices establishing connections with diverse and heterogeneous 802.11 wireless networks that the mobile device encounters along its path, such as wireless local area networks (WLANs).

Multiple technical challenges must be addressed to enable effective mobile device connectivity through 802.11 wireless networks. First, a mobile device must be capable of establishing an opportunistic connection to various 802.11 wireless networks in its vicinity, utilizing a network for desired data transfer while within a coverage area. Second, roaming between access points (APs) must be fast and seamless. For example, a mobile device may need to roam every few seconds at speeds of forty kilometers per hour, necessitating fast transitions to effectively utilize the 802.11 wireless networks. Third, traffic must be handled by APs of any deployment while preserving confidentiality and privacy.

The present disclosure addresses these challenges through a session management approach that utilizes an out-of-band (OOB) connection. The disclosed system enables efficient Wi-Fi data offloading from a mobile device moving through a potentially non-contiguous Wi-Fi coverage area, provides enhanced scanning and session establishment with accelerated key negotiation, and maintains long-lived session management as the mobile device traverses areas with intermittent Wi-Fi coverage.

The hybrid architecture described herein implements a session control method for establishing and maintaining a Wi-Fi association for a moving mobile device in scenarios where the mobile device has access to a highly available and reliable OOB network connection, such as cellular or satellite connectivity. The OOB network connection may be more costly or constrained to utilize than available Wi-Fi networks. Therefore, mobile devices will connect to 802.11 wireless networks when possible, to offload high-volume bursty traffic, such as infotainment streaming, software updates, or offline map updates, to lower-cost Wi-Fi connections that lack broad coverage areas. By utilizing the OOB connection to establish an 802.11 association, including authentication, prior to entering the actual WLAN coverage zone, the disclosed system maximizes the efficiency of data transfer during the limited time the mobile device remains within Wi-Fi coverage.

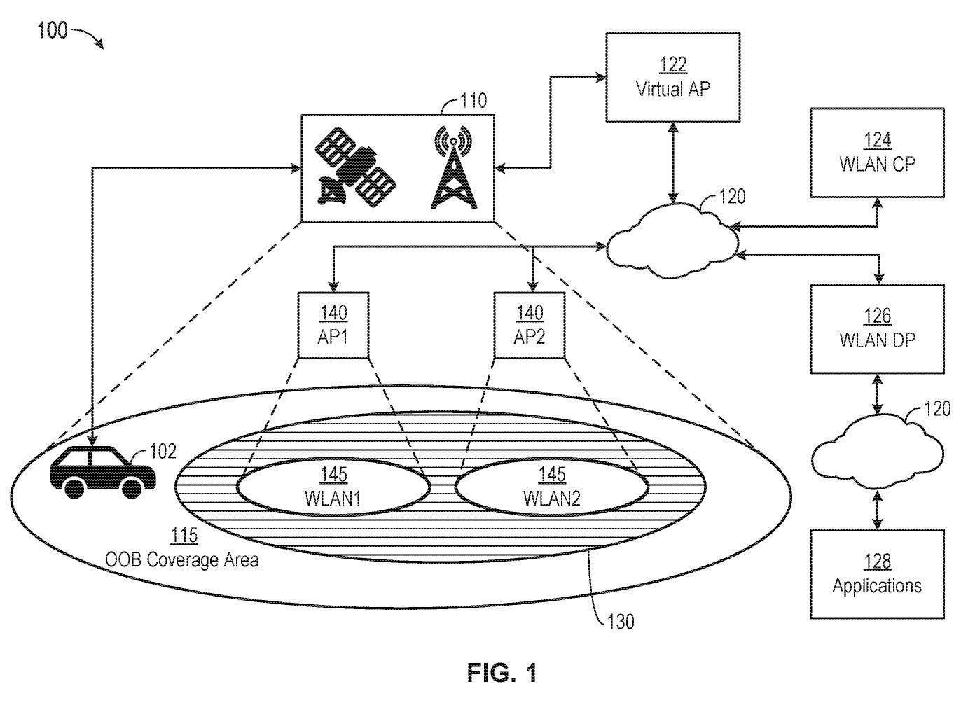

FIG. 1 is a block diagram of an operating environment 100 for hybrid Multi-Link Device (MLD) wireless networking. The operating environment 100 includes a mobile device 102 configured to utilize a hybrid MLD wireless networking architecture to opportunistically connect to 802.11 wireless networks when within coverage areas. In the illustrated embodiment, the mobile device 102 is a vehicle equipped with one or more systems, such as vehicle control systems, vehicle information systems, infotainment systems, and positioning systems (e.g., GPS). The mobile device 102 can connect to 802.11 wireless networks for transmitting and receiving data for any of its systems, including streaming of audio and video content via infotainment systems, software updates, and offline map updates.

The operating environment 100 also includes OOB infrastructure 110, such as satellite communication infrastructure and/or cellular communication infrastructure. The mobile device 102 is configured to communicate OOB via the OOB infrastructure 110 while within an OOB coverage area 115. The OOB connection provides a highly available and reliable communication link that typically offers broader geographic coverage than WLAN infrastructure, though it may be more costly or have bandwidth constraints compared to Wi-Fi connections. As will be described in further detail herein, the mobile device 102 utilizes the OOB connection for control plane communications, including service discovery, session establishment, and exchange of location and network topology information.

A wide area network (WAN) 120 (e.g., the Internet or other packet data network) connects and otherwise enables communication between components of the operating environment 100, including a virtual AP 122, a WLAN control plane (CP) 124, a WLAN data plane (DP) 126, applications 128, and physical APs 140. The APs 140 create WLANs with various WLAN coverage areas 145. The WLAN coverage areas 145 are geofences indicating an area where the mobile device 102 can connect to the respective AP 140 in certain embodiments. In the illustrated embodiment, the AP1 140 creates the WLAN1 coverage area 145 and the AP2 140 creates the WLAN2 coverage area 145. The WLAN coverage areas 145 may be in a service area 130 that defines a geographic region where the mobile device 102 can establish and maintain 802.11 wireless network sessions via one or more of the APs 140 when the mobile device 102 is positioned in a respective WLAN coverage area 145. The service area 130 may be a session establishment geofence that controls whether the mobile device 102 can initiate a session with the 802.11 network, receive certain information, activate virtual interfaces, connect to the virtual AP 122, connect to the APs 140, and the like.

The WLAN coverage areas 145 can cover different geographic areas and may overlap for seamless roaming when the mobile device 102 leaves a respective WLAN coverage area 145 and enters another. For nonoverlapping WLAN coverage areas 145, the connection to the 802.11 wireless network may be paused or suspended until the mobile device 102 enters another WLAN coverage area 145. In urban environments and other deployment scenarios, WLAN coverage may be non-contiguous or spotty, with physical APs 140 deployed at specific locations such as gas stations, charging stations, parking facilities, retail establishments, or along certain roadways, rather than providing continuous coverage throughout the service area 130.

In certain embodiments, the mobile device 102 and/or the APs 140 are MLDs capable of operating across multiple frequency bands and establishing multiple concurrent links. The mobile device 102 can perform seamless or otherwise improved roaming between APs 140 using multiple available links. For example, the mobile device 102 may be initially positioned in the WLAN1 coverage area 145 and communicating with the AP1 140 via a link using a first frequency. As the mobile device 102 approaches the WLAN2 coverage area 145, the mobile device 102 and the AP2140 can setup a link using a second frequency, enabling the mobile device 102 to continue communicating with the AP1 140 while setting up the new link and then seamlessly transition to communicating with the AP2 140 using the newly established link. This approach enables make-before-break roaming (MBBR) when supported by the MLD APs 140 and the mobile device 102. In some embodiments, the mobile device 102 is a hybrid MLD with both physical interfaces and virtual interfaces.

As illustrated, the OOB coverage area 115 covers a larger geographic area than the service area 130, so the mobile device 102 can perform OOB communications prior to being positioned within the service area 130. The mobile device 102 can therefore utilize OOB communications to discover WLAN service availability, including the presence and positions of the APs 140 and/or the positions of the WLAN coverage areas 145 before entering the service area 130. When OOB communications are not available, the mobile device 102 can perform traditional over-the-air scanning for available networks.

In some embodiments, the mobile device 102 stores a coverage map that indicates the presence and positions of APs 140, the positions of the WLAN coverage areas 145, positions of service areas 130, and/or the like. The mobile device 102 can obtain and update the coverage map via OOB signaling and when connected to an 802.11 wireless network (e.g., via an AP 140). When the mobile device 102 has a current coverage map, the mobile device 102 can determine when to activate 802.11 scanning and session establishment without needing to perform real-time service discovery.

The mobile device 102 can also use the OOB connection to establish a control tunnel to one or multiple of the available WLANs prior to or when entering the service area 130. The mobile device 102 can establish the 802.11 association, authentication, and key exchange over the OOB connection before physically entering a WLAN coverage area 145. This pre-establishment of the 802.11 session enables the mobile device 102 to begin data transmission when it enters a WLAN coverage area 145 and connects to one of the APs 140, maximizing the efficiency of data transfer during the limited time the mobile device 102 remains within Wi-Fi coverage. In certain embodiments, the mobile device 102 communicates with the virtual AP 122 to perform the association, authentication, and key exchange via the OOB connection. The mobile device 102 can associate to the virtual AP 122 before entering a WLAN coverage area 145.

The virtual AP 122 is a software component that operates independently of physical wireless radio hardware and is reachable via the OOB connection and/or the WAN 120. In one embodiment, the virtual AP 122 is implemented as a cloud-based service. The virtual AP 122 can terminate virtual 802.11 interface connections from mobile devices 102 that tunnel 802.11 protocol messages over IP connections established through the OOB infrastructure 110. The virtual AP 122 enables the mobile device 102 to establish and maintain 802.11 associations, perform authentication procedures, and complete key handshakes even when the mobile device 102 is outside physical WLAN coverage areas 145. The virtual AP 122 can also maintain a session state for the mobile device 102 and coordinate with the WLAN CP 124 to manage session continuity as the mobile device 102 moves through the service area 130. In certain embodiments, the virtual AP 122 implements an AP MLD that can establish multi-link connections with non-AP MLDs on the mobile device 102, enabling the mobile devices 102 to add and remove physical links to physical APs 140 while maintaining a persistent virtual link to the virtual AP 122.

The WLAN CP 124 provides centralized control plane functions for managing WLAN services across both virtual and physical network infrastructure. The WLAN CP 124 operates as a WLAN controller or cloud management entity that manages the virtual AP 122 and the physical APs 140. The WLAN CP 124 handles service discovery requests from mobile devices 102, including geographical WLAN discovery requests that include the mobile device's position and optionally its intended path or speed. Based on the mobile device's location, the WLAN CP 124 responds with information about available WLAN services (e.g., AP 140 positions), service areas 130 (e.g., session establishment geofences), WLAN coverage geofences (e.g., WLAN service areas 145), and connection parameters for associating with the virtual AP 122. The WLAN CP 124 can also manage authentication flows by coordinating with Authentication, Authorization, and Accounting (AAA) servers to authenticate mobile devices 102 during session establishment. The WLAN CP 124 can provide geographical neighbor reports that include the identifiers, geographic positions, expected coverage areas, bands/channels, and capability information for physical APs 140 near the mobile device's reported position. Additionally, the WLAN CP 124 pushes session information and key material to physical APs 140 when a mobile device 102 is approaching or entering a WLAN coverage area 145, enabling fast link establishment without requiring full authentication at the physical AP 140.

The WLAN DP 126 handles user plane traffic forwarding and data path operations for mobile devices 102 connected through the WLAN infrastructure. The WLAN DP 126 routes data packets between mobile devices 102 connected to physical APs 140 and destination endpoints accessible via the WAN 120, such as the applications 128 or other network resources. The WLAN DP 126 may implement traffic management, quality of service policies, and security enforcement for data flowing through the WLAN infrastructure. In certain embodiments, the WLAN DP 126 coordinates with the WLAN CP 124 to receive session state information and forwarding rules for active mobile device 102 sessions.

The applications 128 are backend services, content servers, and remote systems with which the mobile device 102 communicates when connected through the WLAN infrastructure. The applications 128 may include streaming media services for infotainment content, software update servers for vehicle system updates, map data servers for offline map downloads, vehicle management services operated by vehicle manufacturers, and other network-accessible services. The mobile device 102 accesses the applications 128 via the data plane path through physical APs 140, the WLAN DP 126, and the WAN 120 when positioned within WLAN coverage areas 145.

In certain embodiments, the operating environment 100 also includes infrastructure services such as AAA servers for authentication, authorization, and accounting functions, and Domain Name System (DNS) servers for service discovery. The mobile device 102 uses DNS to discover the WLAN Application Programming Interface (API) service when establishing the initial OOB connection to the WLAN infrastructure. The AAA servers authenticate mobile devices 102 during 802.11 session establishment, supporting authentication protocols such as 802.1x/EAP and federated authentication schemes.

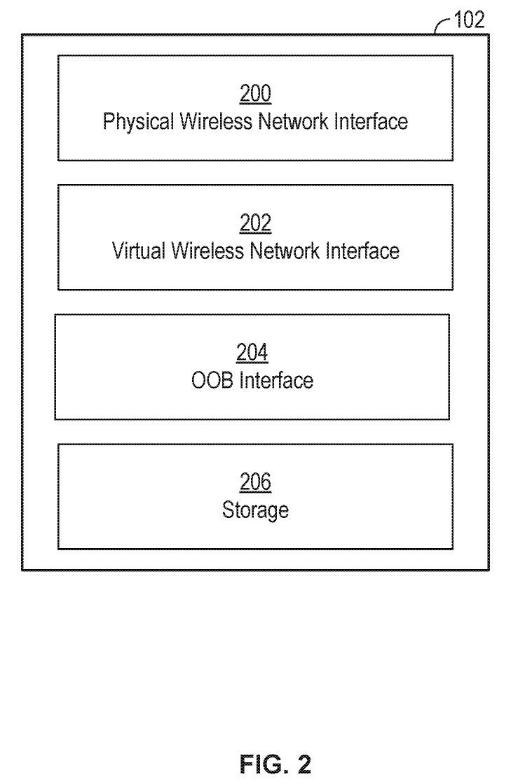

FIG. 2 illustrates an example mobile device 102 with multiple components for utilizing the hybrid MLD wireless networking architecture. In the illustrated embodiment, the mobile device 102 includes a physical wireless network interface 200, a virtual wireless network interface 202, an OOB interface 204, and storage 206. Therefore, the mobile device 102 is a hybrid MLD with both a physical wireless network interface 200 and a virtual wireless network interface 202.

The physical wireless network interface 200 is configured to establish WLAN connections with APs 140 and other devices, according to IEEE 802.11 standards for example. The physical wireless network interface 200 includes radio frequency hardware capable of transmitting and receiving wireless signals in one or more frequency bands, such as 2.4 GHz, 5 GHz, or 6 GHz bands. The physical wireless network interface 200 can also perform over-the-air scanning to detect available APs 140 within range and establish physical layer connections to an AP 140 when the mobile device 102 is within WLAN coverage areas 145, such as when OOB communications are not available. Once a connection is established through the physical wireless network interface 200, the mobile device 102 can transmit and receive high-volume data traffic, such as infotainment streaming, software updates, or offline map updates.

The virtual wireless network interface 202 is also configured for IEEE 802.11 communications but operates as a software-based interface rather than a physical radio. The virtual wireless network interface 202 establishes 802.11 associations and performs authentication procedures over the OOB interface 204 by tunneling 802.11 protocol messages through an alternate network connection. Thus, the mobile device 102 can use the virtual wireless network interface 202 to communicate with the virtual AP 122. This enables the mobile device 102 to complete session establishment, including authentication and key exchange, prior to entering the actual WLAN coverage areas 145 served by physical APs 140. The virtual wireless network interface 202 can maintain an active 802.11 session even when the mobile device 102 is outside physical WLAN coverage areas 145, thereby preserving session state as the mobile device 102 moves through non-contiguous coverage zones.

The OOB interface 204 provides connectivity through a network distinct from the WLAN infrastructure, including for communications via the OOB infrastructure 110. The mobile device 102 can utilize the OOB interface 204 to establish communications with the WLAN CP 124 and WLAN infrastructure, including service discovery, session establishment via the virtual wireless network interface 202, and exchange of location information and network topology data. The OOB interface 204 enables the mobile device 102 to maintain connectivity with the WLAN CP 124 even when physically separated from APs 140.

The storage 206 comprises memory space for downloading and storing data. For example, the storage 206 can store coverage maps that define geographical areas where WLAN services are available, including positions of service areas 130, positions of APs 140, positions of WLAN coverage areas 145, and the like. The storage 206 can therefore store service area 130 positions that indicate where the mobile device 102 should initiate virtual 802.11 sessions, as well as WLAN coverage areas 145 that define specific coverage areas of individual APs 140. The coverage maps may include AP identifiers, geographical positions, channel information, and other parameters received from the WLAN infrastructure. The mobile device 102 uses information stored in storage 206, in combination with its own location positioning system (e.g., GPS), to determine when to activate scanning on the physical wireless network interface 200 and when to initiate roaming procedures between APs.

In one embodiment, the mobile device 102 implements a non-AP MLD that coordinates operations between the physical wireless network interface 200 and the virtual wireless network interface 202 to maintain simultaneous associations over both interfaces. This configuration enables the mobile device 102 to use Multi-Link Operation (MLO) techniques to add and remove links as the mobile device 102 enters and exits coverage areas of physical access points while maintaining continuous session state through the virtual wireless network interface 202.

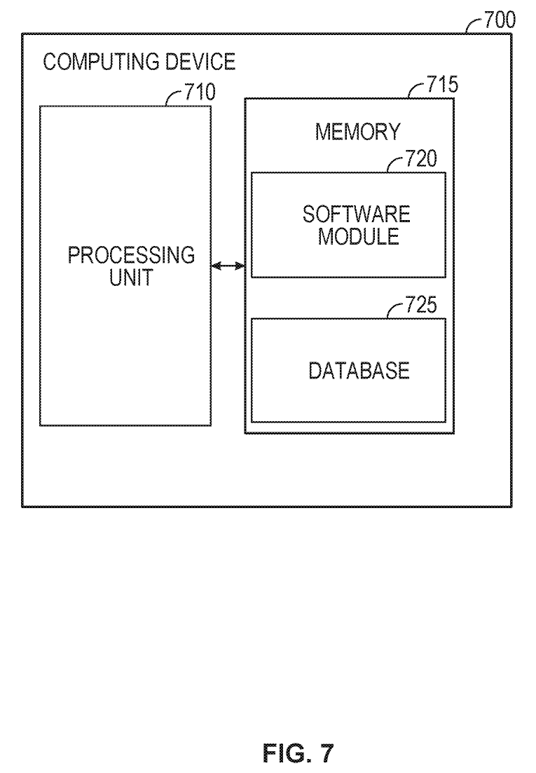

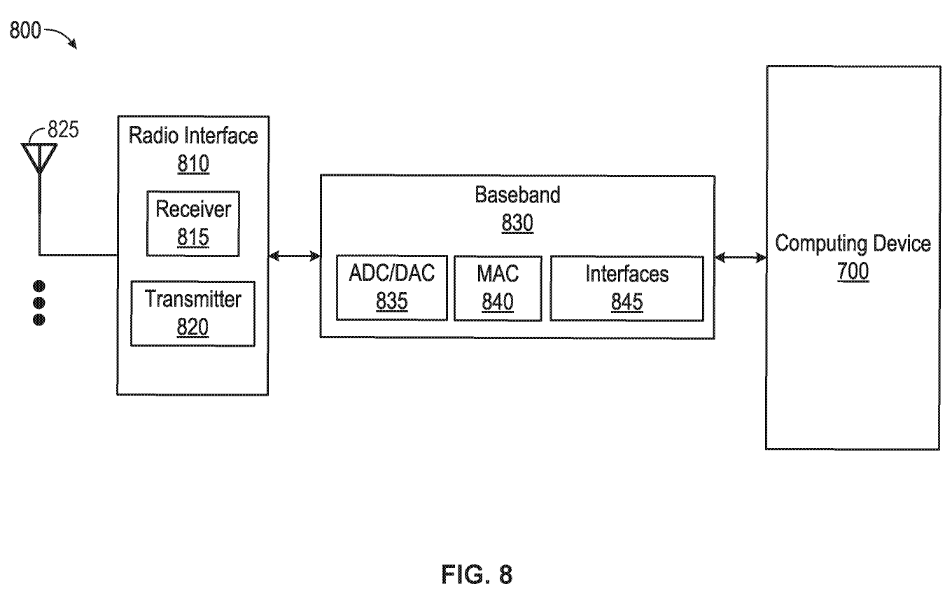

The elements described above of the operating environment 100 (e.g., the mobile device 102, the OOB infrastructure 110, the virtual AP 122, the WLAN CP 124, the WLAN DP 126, the applications 128, the APs 140, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 7 and 8, the elements of the operating environment 100 may be practiced in a computing device 700 and/or communications device 800.

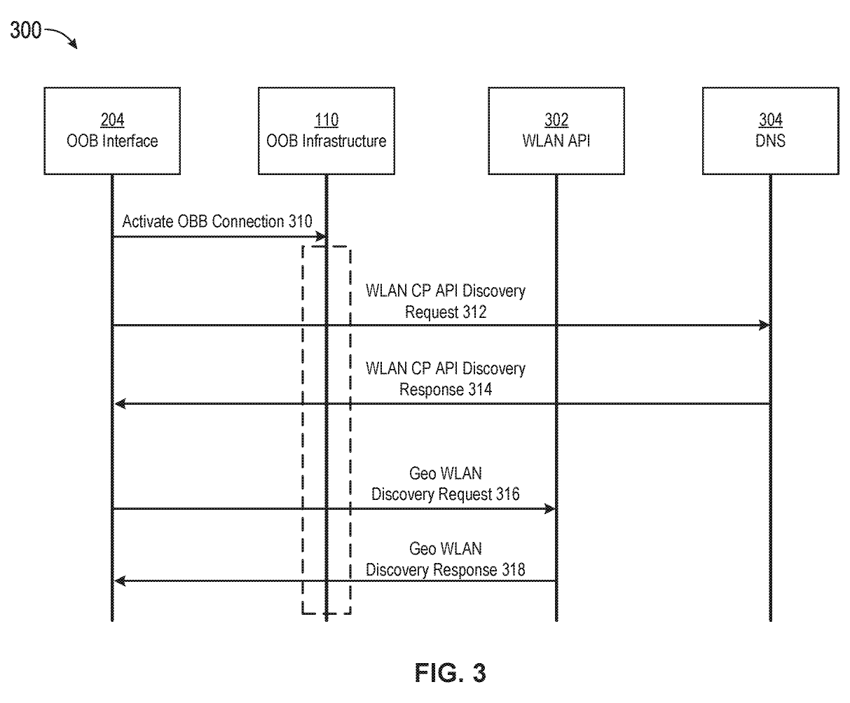

FIG. 3 is a diagram of a service availability determination process 300. The mobile device 102 can initiate the service availability determination process 300 when within the OOB coverage area 115, allowing the mobile device 102 to discover the availability of WLAN services, determine positions of service areas 130 and APs 140, and obtain other information for determining when and where to establish a session for connecting to 802.11 wireless networks.

The service availability determination process 300 can be performed by the mobile device 102 using the OOB interface 204, the OOB infrastructure 110, a WLAN API 302, and a DNS server 304. Initially, the mobile device 102 establishes a connection with the OOB infrastructure 110, such as by sending an activate OOB connection signal 310. In embodiments where the OOB infrastructure 110 cannot be connected to (e.g., when the mobile device 102 is in a remote site or underground parking facility outside the OOB coverage area 115), the mobile device 102 can perform traditional over-the-air scanning for available networks. In certain embodiments, the mobile device 102 may rely on a pre-loaded coverage map stored in storage 206 rather than performing real-time service discovery.

Once the OOB connection is established, the mobile device 102 communicates with the DNS server 304 to discover the WLAN API 302. For example, the mobile device 102 sends a WLAN CP API discovery request 312 to the DNS server 304, and the DNS server replies with a WLAN CP API discovery response 314. The WLAN CP API discovery response 314 contains the information necessary to communicate with the WLAN API 302, such as a network address, service endpoint identifier, security parameters, and connection details. In one embodiment, the WLAN API 302 is implemented as part of or in communication with the WLAN CP 124.

The mobile device 102 then performs a call to the WLAN API 302 service, sharing its known local position via a geographical (Geo) WLAN discovery request 316. The Geo WLAN discovery request 316 can include accuracy metrics of the mobile device’s position, and in some embodiments may also include the mobile device's trip path, speed, intended path, or most-likely path to enable wide-range discovery.

The WLAN API 302 responds with a Geo WLAN discovery response 318. If the mobile device 102 is far from any service areas 130, the Geo WLAN discovery response 318 may be empty or indicate the closest OOB WLAN virtual AP (e.g., the virtual AP 122). If the mobile is either inside or near a service area 130, the Geo WLAN discovery response 318 will indicate one or more OOB WLAN virtual APs that the mobile device 102 can connect to. Each virtual AP indicated in the Geo WLAN discovery response 318 will include information about its service area 130 (e.g., the location of the center and radius, a polygon indicating the geographic scope of the service area 130, etc.) and details about the service, such as network name, type of network (local versus federated/roaming), authentication details, transport details, and virtual 802.11 interface addresses. In the illustrated embodiment shown in FIG. 1, the Geo WLAN discovery response 318 includes information for communicating with the virtual AP 122, information for determining the geographical scope of the service area 130, and details about the service within the service area 130.

When the mobile device 102 provides its position along with trip path, speed, or intended path information, the WLAN API 302 can respond with a wide-range discovery response that includes details about service areas 130 that the mobile device 102 will likely reach soon, enabling proactive session planning. Identifying service areas 130 the mobile device 102 will likely reach may be based on a calculated probability being above a threshold value.

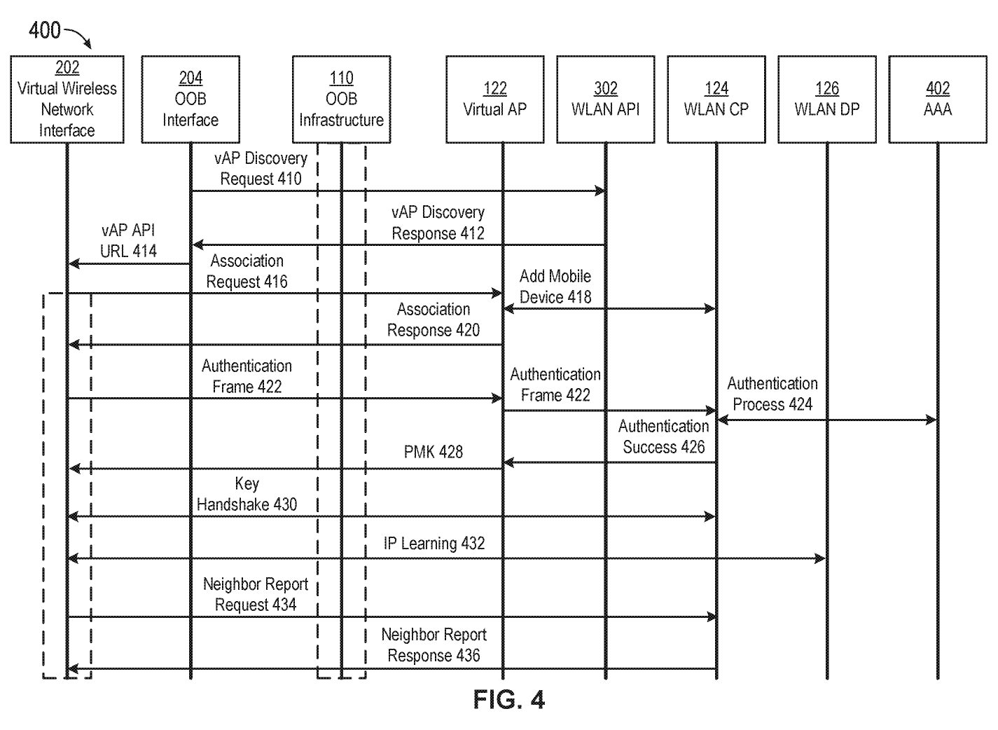

FIG. 4 is a diagram of a session establishment process 400. The mobile device 102, operating as a hybrid non-AP MLD, initiates the session establishment process 400 when the mobile device 102 detects it is entering a service area 130. Once the mobile device 102 determines it is entering the service area 130, the mobile device 102 activates the virtual wireless network interface 202 to connect to the virtual AP 122 indicated in the Geo WLAN discovery response 318.

In some embodiments, the mobile device 102 establishes a tunnel towards the virtual AP 122 prior to establishing the virtual 802.11 session, with tunnel establishment details provided as part of the Geo WLAN discovery response 318. In various embodiments, the tunnel may be implemented using VPN protocols, secure IP tunneling, or other encapsulation methods that enable 802.11 protocol messages to be carried over the OOB connection.

During the session establishment process 400, the mobile device 102 establishes an 802.11 association and authentication over the virtual wireless network interface 202. This process is equivalent or similar to the standard 802.11 authentication and association, including performing authentication following the security policy from the WLAN. In the illustrated embodiment, the association and authentication process includes the mobile device 102 sending a virtual AP discovery request 410 to the WLAN API 302. The WLAN API 302 responds with a virtual AP discovery response 412 including a virtual AP 122 information 414 (e.g., a virtual AP API uniform resource locator (URL)) for the virtual wireless network interface 202 to connect with the virtual AP 122. The mobile device 102 then sends an association request 416 to the virtual AP 122 using the virtual wireless network interface 202. The virtual AP 122 and the WLAN CP 124 perform an add mobile device process 418 for the WLAN CP 124 to register or otherwise add the mobile device 102 in its managed session. The virtual AP 122 then provides an association response 420 to the mobile device 102.

The mobile device 102 sends an authentication frame 422 to the virtual AP 122, and the virtual AP 122 forwards the authentication frame 422 or otherwise communicates the authentication request to the WLAN CP 124. The WLAN CP 124 and an AAA server 402 perform an authentication process 424 to authenticate the mobile device 102. In certain embodiments, the authentication process 424 involves 802.1x/EAP authentication and may support federated authentication schemes such as OpenRoaming. The authentication process 424 can include a Remote Authentication Dial-In User Service (RADIUS) access request message, RADIUS exchange messages, and a RADIUS access success message including a pairwise master key (PMK). The WLAN CP 124 sends an authentication success frame 426 with the PMK to the virtual AP 122, and the virtual AP 122 provides the PMK via a PMK signal 428 to the mobile device 102. Using the PMK, the mobile device 102 and the WLAN CP 124 perform a key handshake 430, completing the security association for the virtual 802.11 session. The mobile device 102 and the WLAN DP 126 then perform an Internet Protocol (IP) learning process 432 for the WLAN to discover and record the IP address assigned to the mobile device 102.

The mobile device 102 also shares with the WLAN infrastructure its own geographical position during or after the session establishment process 400. The mobile device 102 can also provide movement information in example implementations. In some embodiments, the mobile device 102 shares its location during the association phase. In other embodiments, the mobile device 102 shares its location after the session establishment with the WLAN is complete (e.g., after the key handshake 430), such as via a specific action frame.

To receive information for connecting to nearby physical APs 140, the mobile device 102 sends a neighbor report request 434 to the WLAN CP 124. In some embodiments, the neighbor report request 434 includes the position and/or movement of the mobile device 102 if not previously shared during the association phase.

The WLAN CP 124 responds with a neighbor report response 436, which in one embodiment comprises a Geo neighbor report that includes geographical positioning information for nearby APs 140. The neighbor report response 436 includes a list of the nearest physical APs 140 based on the mobile device's shared position and may also include information associated with service areas 130 and/or WLAN coverage areas 145. For each AP 140 in the list, the neighbor report response 436 can include an identifier of the AP 140 (e.g., a Basic Service Set Identifier (BSSID)), the geographical position of the AP 140, the respective WLAN coverage area 145 (e.g., the position of the center of the area and its radius, geo-referenced polygon, etc.), which bands and/or channels are in use, AP capability information, privacy parameters exchanged with AP 140 (e.g., if support 802.11bi) to re-establish connection in future, and other relevant parameters.

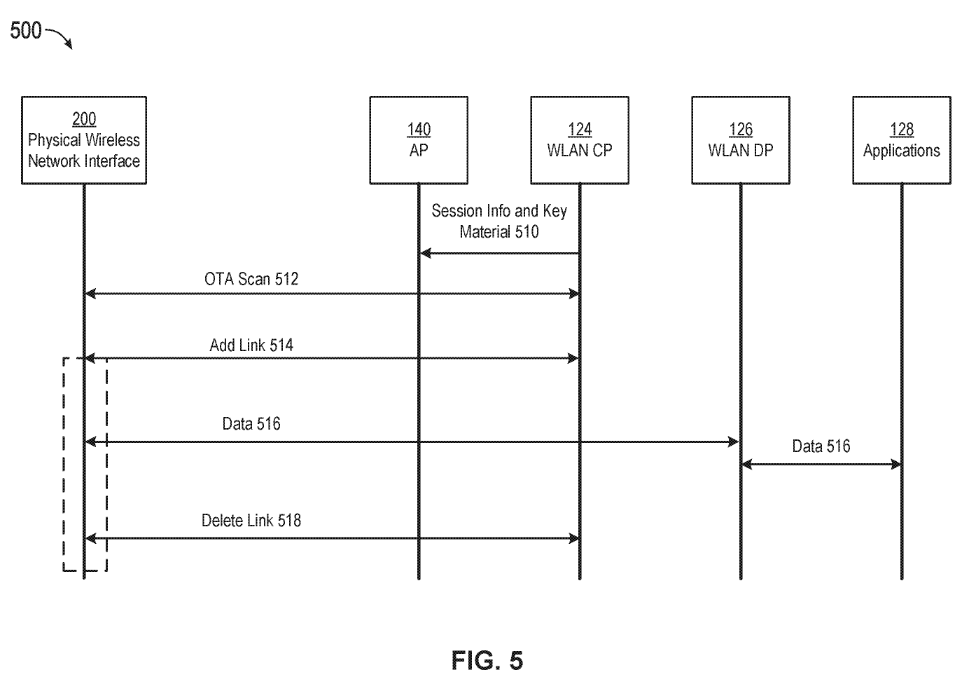

FIG. 5 is a diagram of an AP link establishment process 500 performed when entering a WLAN coverage area 145. The mobile device 102 can initiate the AP link establishment process 500 by sending its updated position to the WLAN infrastructure (e.g., via the OOB interface 204). The updated position indicates the closest known AP 140 and thereby which WLAN coverage area 145 the mobile device 102 is entering.

Based on the mobile device's reported position, the WLAN CP 124 sends a communication 510 including mobile device 102 session info and key material to the AP 140 associated with the WLAN coverage area 145 the mobile device 102 is entering and, optionally, to other neighbor APs 140. In certain embodiments, the WLAN CP 124 may opportunistically push the session info and key material to a given AP 140 if the WLAN infrastructure predicts the mobile device 102 will associate soon based on its location and movement, even before receiving an explicit position update. By receiving the session information and key material in advance, the AP 140 can allow the mobile device 102 to add links without requiring full authentication procedures at the AP 140. The mobile device 102 can therefore exchange data over the network immediately upon entering a WLAN coverage area 145 or otherwise more quickly than if the mobile device 102 needed to perform association and authentication when entering the WLAN coverage area 145.

To connect to an AP 140, the mobile device 102 performs over-the air scanning 512 using the physical wireless network interface 200 on the channels reported in the neighbor report response 436 for the closest known AP 140. Once the mobile device 102 discovers the AP 140, the mobile device 102 performs an add-link operation 514 to setup a link with the AP 140.

Once the link with the AP 140 is established, the mobile device 102 transmits data 516 over the link. The AP 140 and WLAN DP 126 route the data 516 between one or more applications 128 and the mobile device 102. In example implementations, the mobile device 102 can also receive data 516 over a previously associated link (e.g., when using multiple links to connect to various APs 140 in overlapping coverage areas).When the mobile device 102 approaches the edge of the WLAN coverage area 145 for the AP 140 with which it has an active link, the mobile device 102 can perform a delete link operation 518 (e.g., remove link operation) to remove the respective link.

The mobile device 102 can also use the most current neighbor report it has to identify other APs 140 to roam to as the mobile device 102 moves through the service area 130. If one or more APs 140 are available, the mobile device 102 can perform the scanning process 512 again and execute roaming procedures. The mobile device 102 can remove the link from the current AP 140 and then add the link to the next AP 140, or the mobile device 102 can add the link to the next AP 140 before removing the link to the current AP 140 if MBBR is supported by the mobile device 102 and the APs 140.

If no more APs 140 are available when the mobile device 102 leaves a WLAN coverage area 145, the mobile device 102 will perform the delete link operation 518 on the current AP 140 and maintain the active session over the virtual AP 122 link. The mobile device 102 continues to operate as a hybrid non-AP MLD with only the virtual link active. The 802.11 session of the mobile device 102 is maintained active using signaling with management frames over the virtual AP 122 link via the OOB connection until the mobile device 102 leaves the service area 130. When the mobile device 102 leaves the service area 130, the mobile device 102 can deauthenticate with the virtual AP 122, and the virtual AP 122 instructs the WLAN CP 124 to delete the mobile device 102 from its active sessions.

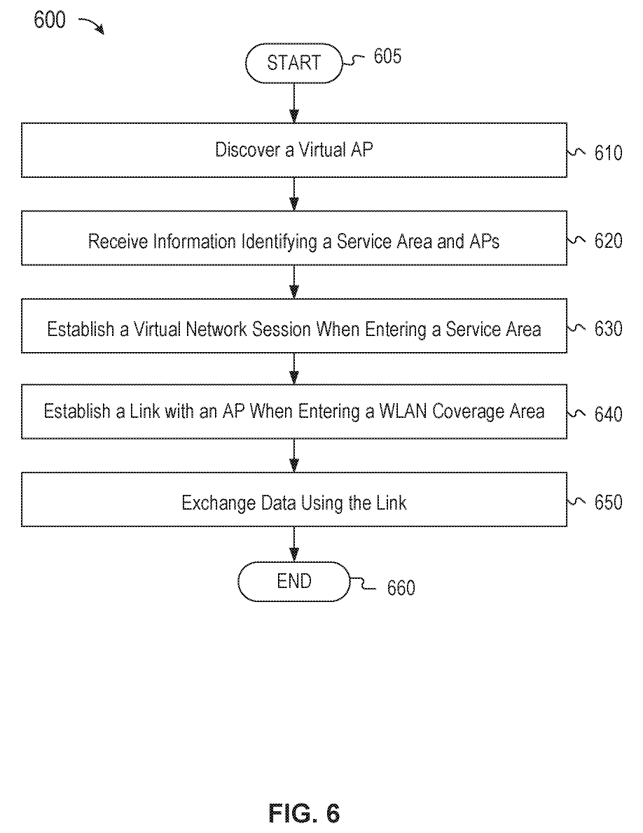

FIG. 6 is a flow chart of a method 600 for hybrid MLD wireless networking. The method 600 begins at starting block 605 and proceeds to operation 610. In operation 610, the mobile device 102, using the OOB connection, discovers the virtual AP 122 that provides WLAN services. The discovering can include the mobile device 102 sending a Geo WLAN discovery request to WLAN infrastructure including a geographical position of the mobile device 102, and receiving a Geo WLAN discovery response indicating the virtual AP 122 from the WLAN infrastructure, wherein the virtual AP 122 is determined based on the geographical position of the mobile device 102.

In operation 620, the mobile device 102 receives, from the virtual AP 122 via the OOB connection, information identifying a service area 130 and information identifying one or more APs 140 within the service area 130. The information identifying the service area 130 and the information identifying the one or more APs 140 within the service area can comprise a Geo neighbor report. For a respective AP of the one or more APs 140, the Geo neighbor report can include an identifier of the respective AP, a geographical position of the respective AP, position information of a respective WLAN coverage area 145 of the respective AP, a band or channel in use by the respective AP, capability information of the respective AP, and/or privacy parameters of the respective AP.

In operation 630, the mobile device 102 establishes a virtual wireless network session with the virtual AP 122 over the OOB connection in response to determining the mobile device 102 is entering the service area 130. The establishing can include performing an association procedure between the mobile device 102 and the virtual AP 122 and performing an authentication procedure between the mobile device 102 and the virtual AP 122.

In operation 640, a link between the mobile device 102 and the AP 140 is established in response to determining that the mobile device 102 is entering a WLAN coverage area 145 associated with an AP 140.

In operation 650, data is exchanged between the mobile device 102 and an application 128 via the link through the AP 140. In certain embodiments, the mobile device 102 uses a virtual wireless network interface 202 for communicating with the virtual AP 122, wherein the virtual wireless network interface 202 tunnels messages over the OOB connection. The mobile device 102 can also use a physical wireless network interface 200 for communicating with the AP 140.

In some embodiments, the method 600 includes, in response to determining the mobile device 102 is approaching a second WLAN coverage area 145 associated with a second AP 140, establishing a second link between the mobile device 102 and the second AP 140 while maintaining the link with current the AP 140. The link with the current AP 140 can be removed after establishing the second link.

In certain embodiments, the method 600 includes, in response to determining the mobile device 102 is leaving the WLAN coverage area 145, removing the link with the AP 140 and maintaining the virtual wireless network session while within the service area 130 to enable establishing a second link with any of the one or more APs 140. The method 600 can include sending, via the OOB connection, an updated geographical position of the mobile device 102 to WLAN infrastructure, wherein, in response to receiving the updated geographical position, the WLAN infrastructure provides session information and key material to the AP 140 prior to establishing the link. The method 600 concludes at ending block 660.

FIG. 7 is a block diagram of a computing device 700. As shown in FIG. 7, computing device 700 may include a processing unit 710 and a memory unit 715. Memory unit 715 may include a software module 720 and a database 725. While executing on processing unit 710, software module 720 may perform, for example, processes for hybrid MLD wireless networking with respect to FIGS. 1-6. Computing device 700, for example, may provide an operating environment for the mobile device 102, the OOB infrastructure 110, the virtual AP 122, the WLAN CP 124, the WLAN DP 126, the applications 128, the APs 140, and the like. The mobile device 102, the OOB infrastructure 110, the virtual AP 122, the WLAN CP 124, the WLAN DP 126, the applications 128, the APs 140, and the like may operate in other environments and are not limited to computing device 700.

Computing device 700 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 700 may comprise any computer operating environment, such as hand-held devices, multiprocessor systems, microprocessor-based or programmable sender electronic devices, minicomputers, mainframe computers, and the like. Computing device 700 may also be practiced in distributed computing environments where tasks are performed by remote processing devices. The aforementioned systems and devices are examples, and computing device 700 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 700 on the single integrated circuit (chip).

FIG. 8 illustrates an implementation of a communications device 800 that may implement one or more of the mobile device 102, the OOB infrastructure 110, the virtual AP 122, the WLAN CP 124, the WLAN DP 126, the applications 128, the APs 140, etc., of FIGS. 1-5. In various implementations, the communications device 800 may comprise a logic circuit. The logic circuit may include physical circuits to perform operations described for one or more of the mobile device 102, the OOB infrastructure 110, the virtual AP 122, the WLAN CP 124, the WLAN DP 126, the applications 128, the APs 140, etc., of FIGS. 1-5, for example. As shown in FIG. 8, the communications device 800 may include one or more of, but is not limited to, a radio interface 810, baseband circuitry 830, and/or the computing device 700.

The communications device 800 may implement some or all of the structures and/or operations for the mobile device 102, the OOB infrastructure 110, the virtual AP 122, the WLAN CP 124, the WLAN DP 126, the applications 128, the APs 140, etc., of FIGS. 1-5, storage medium, and logic circuit in a single computing entity, such as entirely within a single device. Alternatively, the communications device 800 may distribute portions of the structure and/or operations using a distributed system architecture, such as a client station server architecture, a peer-to-peer architecture, a master-slave architecture, etc.

A radio interface 810, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 810 may include, for example, a receiver 815 and/or a transmitter 820. The radio interface 810 may include bias controls, a crystal oscillator, and/or one or more antennas 825. In additional or alternative configurations, the radio interface 810 may use oscillators and/or one or more filters, as desired.

The baseband circuitry 830 may communicate with the radio interface 810 to process, receive, and/or transmit signals and may include, for example, an Analog-To-Digital Converter (ADC) for down converting received signals with a Digital-To-Analog Converter (DAC) 835 for up converting signals for transmission. Further, the baseband circuitry 830 may include a baseband or Physical layer (PHY) processing circuit for the PHY link layer processing of respective receive/transmit signals. Baseband circuitry 830 may include, for example, a MAC processing circuit 840 for MAC/data link layer processing. Baseband circuitry 830 may include a memory controller for communicating with MAC processing circuit 840 and/or a computing device 700, for example, via one or more interfaces 845.

In some configurations, PHY processing circuit may include a frame construction and/or detection module, in combination with additional circuitry such as a buffer memory, to construct and/or deconstruct communication frames. Alternatively or in addition, MAC processing circuit 840 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Claims:

1. A method comprising:
discovering, by a mobile device and using an out-of-band (OOB) connection, a virtual access point (AP) that provides wireless local area network (WLAN) services;
receiving, from the virtual AP via the OOB connection, information identifying a service area and information identifying one or more APs within the service area;
establishing a virtual wireless network session with the virtual AP over the OOB connection in response to determining the mobile device is entering the service area, the establishing comprising:
performing an association procedure between the mobile device and the virtual AP, and
performing an authentication procedure between the mobile device and the virtual AP;
in response to determining that the mobile device is entering a WLAN coverage area associated with an AP of the one or more APs, establishing a link between the mobile device and the AP; and
exchanging data between the mobile device and an application via the link through the AP.

2. The method of claim 1, wherein discovering the virtual AP comprises:
sending a geographical (Geo) WLAN discovery request to WLAN infrastructure including a geographical position of the mobile device; and
receiving a Geo WLAN discovery response indicating the virtual AP from the WLAN infrastructure, wherein the virtual AP is determined based on the geographical position of the mobile device.

3. The method of claim 1, wherein:
the mobile device uses a virtual wireless network interface for communicating with the virtual AP, wherein the virtual wireless network interface tunnels messages over the OOB connection; and
the mobile device uses a physical wireless network interface for communicating with the AP.

4. The method of claim 1, further comprising:
in response to determining the mobile device is approaching a second WLAN coverage area associated with a second AP of the one or more APs, establishing a second link between the mobile device and the second AP while maintaining the link with the AP; and
removing the link with the AP after establishing the second link.

5. The method of claim 1, wherein the information identifying the service area and the information identifying the one or more APs within the service area comprises a Geo neighbor report, wherein, for a respective AP of the one or more APs, the Geo neighbor report comprises any one of: (i) an identifier of the respective AP, (ii) a geographical position of the respective AP, (iii) position information of a respective WLAN coverage area of the respective AP, (iv) a band or channel in use by the respective AP, (v) capability information of the respective AP, (vi) privacy parameters of the respective AP, or (vii) any combination of (i)-(vi).

6. The method of claim 1, further comprising:
in response to determining the mobile device is leaving the WLAN coverage area, removing the link with the AP; and
maintaining the virtual wireless network session while within the service area to enable establishing a second link with any of the one or more APs.

7. The method of claim 1, further comprising:
sending, via the OOB connection, an updated geographical position of the mobile device to WLAN infrastructure, wherein, in response to receiving the updated geographical position, the WLAN infrastructure provides session information and key material to the AP prior to establishing the link.

8. A system comprising:
a memory storage; and
a processing unit coupled to the memory storage, wherein the processing unit is operative to:
discover, using an out-of-band (OOB) connection, a virtual access point (AP) that provides wireless local area network (WLAN) services;
receive, from the virtual AP via the OOB connection, information identifying a service area and information identifying one or more APs within the service area;
establish a virtual wireless network session with the virtual AP over the OOB connection in response to determining the system is entering the service area, the establishing comprising:
performing an association procedure between the system and the virtual AP, and
performing an authentication procedure between the system and the virtual AP;
in response to determining that the system is entering a WLAN coverage area associated with an AP of the one or more APs, establishing a link between the system and the AP; and
exchanging data between the system and an application via the link through the AP.

9. The system of claim 8, wherein to discover the virtual AP comprises to:
send a geographical (Geo) WLAN discovery request to WLAN infrastructure including a geographical position of the system; and
receive a Geo WLAN discovery response indicating the virtual AP from the WLAN infrastructure, wherein the virtual AP is determined based on the geographical position of the system.

10. The system of claim 8, wherein:
the system uses a virtual wireless network interface for communicating with the virtual AP, wherein the virtual wireless network interface tunnels messages over the OOB connection; and
the system uses a physical wireless network interface for communicating with the AP.

11. The system of claim 8, the processing unit being further operative to:
in response to determining the system is approaching a second WLAN coverage area associated with a second AP of the one or more APs, establish a second link between the system and the second AP while maintaining the link with the AP; and
remove the link with the AP after establishing the second link.

12. The system of claim 8, wherein the information identifying the service area and the information identifying the one or more APs within the service area comprises a Geo neighbor report, wherein, for a respective AP of the one or more APs, the Geo neighbor report comprises any one of: (i) an identifier of the respective AP, (ii) a geographical position of the respective AP, (iii) position information of a respective WLAN coverage area of the respective AP, (iv) a band or channel in use by the respective AP, (v) capability information of the respective AP, (vi) privacy parameters of the respective AP, or (vii) any combination of (i)-(vi).

13. The system of claim 8, the processing unit being further operative to:
in response to determining the system is leaving the WLAN coverage area, remove the link with the AP; and
maintain the virtual wireless network session while within the service area to enable establishing a second link with any of the one or more APs.

14. The system of claim 8, the processing unit being further operative to:
send, via the OOB connection, an updated geographical position of the system to WLAN infrastructure, wherein, in response to receiving the updated geographical position, the WLAN infrastructure provides session information and key material to the AP prior to establishing the link.

15. A non-transitory computer-readable medium that stores a set of instructions which when executed perform a method executed by the set of instructions comprising:
discovering, using an out-of-band (OOB) connection, a virtual access point (AP) that provides wireless local area network (WLAN) services;
receiving, from the virtual AP via the OOB connection, information identifying a service area and information identifying one or more APs within the service area;
establishing a virtual wireless network session with the virtual AP over the OOB connection in response to determining a mobile device is entering the service area, the establishing comprising:
performing an association procedure between the mobile device and the virtual AP, and
performing an authentication procedure between the mobile device and the virtual AP;
in response to determining that the mobile device is entering a WLAN coverage area associated with an AP of the one or more APs, establishing a link between the mobile device and the AP; and
exchanging data between the mobile device and an application via the link through the AP.

16. The non-transitory computer-readable medium of claim 15, wherein discovering the virtual AP comprises:
sending a geographical (Geo) WLAN discovery request to WLAN infrastructure including a geographical position of the mobile device; and
receiving a Geo WLAN discovery response indicating the virtual AP from the WLAN infrastructure, wherein the virtual AP is determined based on the geographical position of the mobile device.

17. The non-transitory computer-readable medium of claim 15, wherein:
a virtual wireless network interface is used for communicating with the virtual AP, wherein the virtual wireless network interface tunnels messages over the OOB connection; and
a physical wireless network interface is used for communicating with the AP.

18. The non-transitory computer-readable medium of claim 15, the method executed by the set of instructions further comprising:
in response to determining the mobile device is approaching a second WLAN coverage area associated with a second AP of the one or more APs, establishing a second link between the mobile device and the second AP while maintaining the link with the AP; and
removing the link with the AP after establishing the second link.

19. The non-transitory computer-readable medium of claim 15, wherein the information identifying the service area and the information identifying the one or more APs within the service area comprises a Geo neighbor report, wherein, for a respective AP of the one or more APs, the Geo neighbor report comprises any one of: (i) an identifier of the respective AP, (ii) a geographical position of the respective AP, (iii) position information of a respective WLAN coverage area of the respective AP, (iv) a band or channel in use by the respective AP, (v) capability information of the respective AP, (vi) privacy parameters of the respective AP, or (vii) any combination of (i)-(vi).

20. The non-transitory computer-readable medium of claim 15, the method executed by the set of instructions further comprising:
in response to determining the mobile device is leaving the WLAN coverage area, removing the link with the AP; and
maintaining the virtual wireless network session while within the service area to enable establishing a second link with any of the one or more APs.
